(19) United States
(12) Patent Application Publication
(10) Pub. No.: US 2010/0209864 A1
(43) Pub. Date: Aug. 19, 2010

(54) TEMPERING CHAMBER FOR TEMPERING ELECTRONIC COMPONENTS IN PARTICULAR IC'S

(75) Inventors: Franz Pichl, Ubersee (DE); Gunther Jeserer, Tuntenhausen (DE); Alexander Bauer, Rosenheim (DE); Andreas Wiesbock, Stephanskirchen (DE)

Correspondence Address: NIXON & VANDERHYE, PC, 901 NORTH GLEBE ROAD, 11TH FLOOR, ARLINGTON, VA, 22203, US

(73) Assignee: Multitest Elektronische Systeme GmbH, Rosenheim (DE)

(21) Appl. No.: 12/681,706

(22) PCT Filed: Sep. 25, 2008
(86) PCT No.: PCT/EP2008/008158

§ 371 Date: Apr. 23, 2010

(30) Foreign Application Priority Data
Oct. 5, 2007 (DE) 10 2007 047 772.6

(51) Int. Cl. F27B 9/16

(52) U.S. Cl. 432/249

(57) ABSTRACT

The invention relates to a tempering chamber for tempering electronic components, in particular, IC's, with a circulating device (15) with a number of carrier elements (18) running in a circle and two support devices arranged on opposite sides of the carrier elements (18) are provided within a housing (14), wherein the carrier elements (18) are mounted on said support elements such that the alignment of the carrier elements (18) is unaltered on circulation.

The invention relates to a temperature-control chamber for controlling the temperature of electronic components, ICs in particular, according to the preamble of claim 1.

Electronic components such as ICs (semiconductor components with integrated circuits) are usually tested for their functionality before they are mounted on printed circuit boards, for example, or used otherwise. The components to be tested are conveyed at high speed by an automatic handling machine, usually called a “handler”, to a test device and, following completion of the test process, are sorted depending on the test result.

To be able to carry out the tests under predetermined temperature conditions, it is also known to bring the components to predetermined temperatures in a temperature-control chamber before the test process. These temperatures may be, for example, in a range from −60° C. to +200° C.

The temperature of the components is controlled in a convective and/or conductive manner in an appropriately heat-insulated housing. In the convective temperature-control process, a correspondingly temperature-controlled air or another gas flows over the components in the housing until they have reached the desired temperature. In the conductive temperature-control process, the components rest on a heating or cooling plate, by means of which heat is then transferred to or from the component.

Controlling the temperature of the components is generally a relatively long process since it takes a certain amount of time for the components to be heated or cooled uniformly to the desired temperature. This can slow the test throughput considerably. The desired high levels of throughput frequently cannot be obtained with the known temperature-control chambers.

The object of the invention is to provide a temperature-control chamber of the type mentioned at the outset with which the temperature of electronic components, ICs in particular, can be controlled in a particularly rapid and uniform manner.

The object is achieved according to the invention by a temperature-control chamber with the features of claim 1. Advantageous embodiments of the invention are described in the further claims.

In the temperature-control chamber according to the invention, the holding device arranged within the housing to hold the components has a circulation means comprising a plurality of bearing elements which circulate in a circular manner and two support means, which are arranged on opposite sides of the bearing elements and to which the bearing elements are mounted in such a way that the alignment of the bearing elements remains unchanged as they circulate.

By using an appropriate number of bearing elements in the temperature-control chamber according to the invention, it is thus possible to receive and control the temperature of many components within the housing simultaneously. The components can be loaded and removed very efficiently and rapidly since the continued rotation of the holding device enables the bearing element from which the already temperature-controlled components have been removed to be brought into a position in which it may be provided with new components to be temperature-controlled by moving a short distance only. Furthermore, the temperature-control process can be carried out convectively and very uniformly within the housing since the bearing elements and the components to be temperature-controlled are moved through the housing and exposed to different air flows, thus avoiding any local pockets of heat or cold.

In an advantageous embodiment, the bearing elements consist of rectangular bearing plates or bearing frames which are formed to receive trays on which the components rest. By using trays of this type, a large number of components can be introduced into the temperature chamber simultaneously, thus enabling the loading procedure to be carried out very rapidly. The bearing elements which circulate within the temperature chamber are in this case formed in such a way that the trays can be simply and rapidly pushed or placed onto the bearing elements.

Special transport trays (“carrier trays”) or conventional storage/transport trays (“user trays”) on which the components are arranged individually or support means for interconnected components (“strips”) for example may be used as trays.

In an advantageous embodiment, the support means are formed from a first and a second spider wheel which are rotatable about parallel, but laterally offset axes and comprise rotary arms on which the bearing elements are rotatably mounted. A construction of this type enables the desired circulation of the bearing elements, and therefore of the components to be temperature-controlled, within the temperature chamber to be achieved in a relatively simple manner, the bearing elements always maintaining the desired alignment, in particular alignment in horizontal planes. It is necessary to drive only one of the two spider wheels in order to move the bearing elements. This may be achieved, for example, by a drive motor which is arranged outside the temperature chamber and acts upon one of the two spider wheels. The other spider wheel is rotationally entrained by the bearing elements. Alternatively, drive motors which act on both spider wheels may be provided on both sides of the temperature chamber.

As an alternative to the two spider wheels with laterally offset axes, it would also be possible to maintain the alignment of the bearing elements as they circulate by mounting the bearing elements in lateral sliding block guides which circulate in a circular manner and are provided in the two lateral support means. In this case, the bearing elements may also be rotated by a laterally arranged spider wheel for example or by other drive means which act directly on the bearings of the bearing elements. In this case, “circular” circulation may also mean that the bearing elements circulate in an oval or approximately polygonal circulation path.

In an advantageous embodiment, each bearing element is mounted in the region of two diagonally opposite corners to the rotary arms. This enables the bearing elements to be held in a particularly tilt-resistant position.

In an advantageous embodiment, each spider wheel comprises 2 to 12, preferably 3 to 7, rotary arms which are uniformly distributed over its circumference, In this case, the number of rotary arms or bearing elements expediently corresponds to the number of rest positions through which a bearing element passes until it again reaches its original loading position.

In an advantageous embodiment, the housing comprises a loading and removal opening for trays and a removal opening for the temperature-controlled components, the openings being arranged adjacent to one another in such a way that the tray from which the temperature-controlled components have been removed finds itself, in the next circulation rest position of the holding device, in the region of the loading and removal opening for trays. In this case, the portion of the circumferential path occupied by the empty trays within the temperature chamber is very short, whereas the trays loaded with components may remain in the temperature chamber for a very long time before they are removed from the temperature chamber via the removal opening.

The invention will be described below in greater detail with reference to drawings, in which:

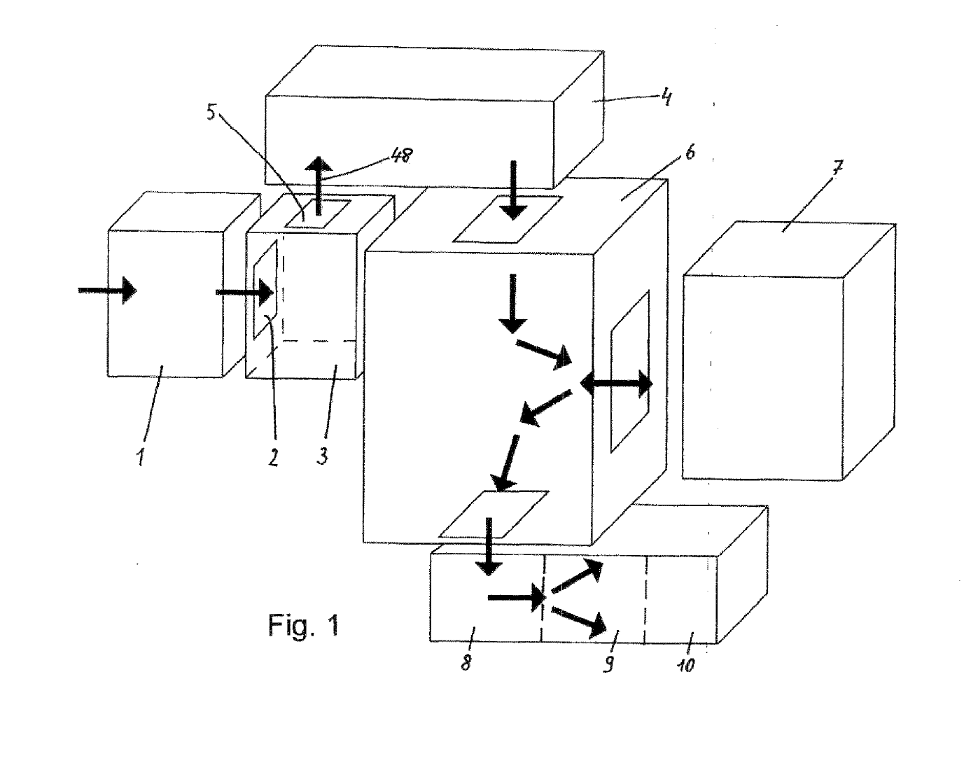

FIG. 1 is a schematic view of the temperature-control chamber according to the invention and the surrounding components which are used to test electronic components,

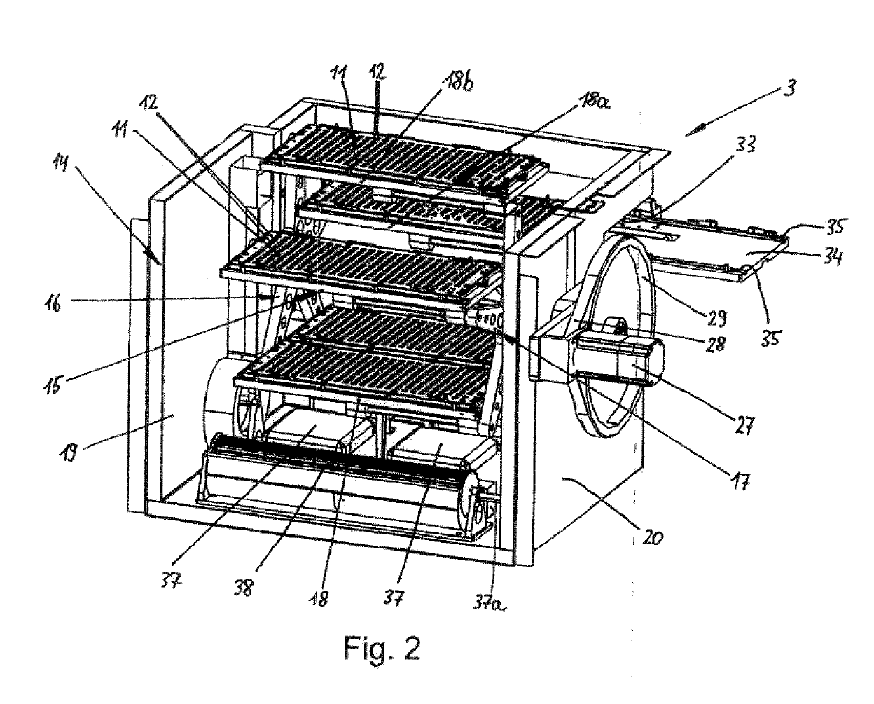

FIG. 2 shows only the temperature-control chamber from FIG. 2,

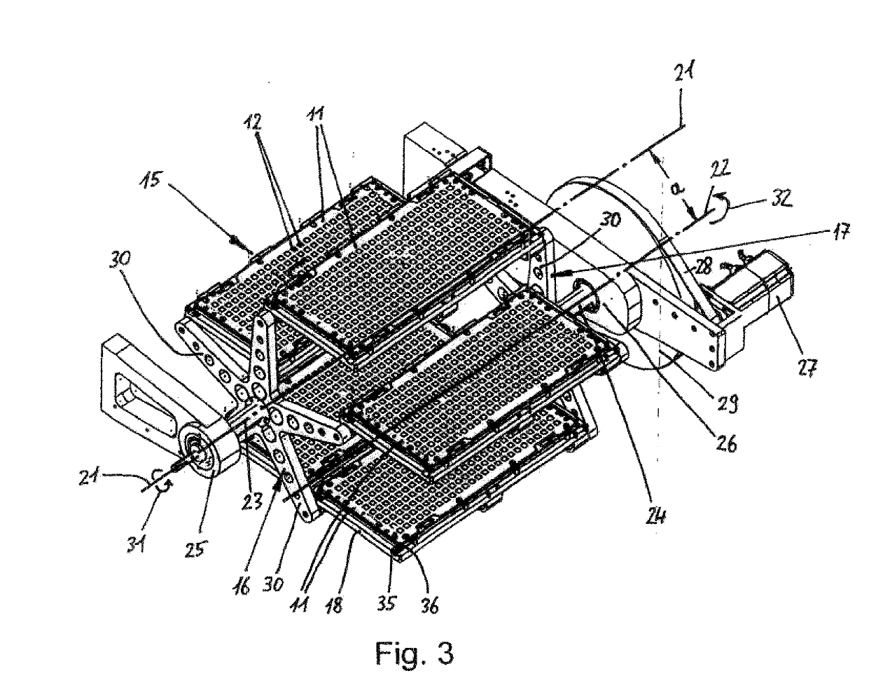

FIG. 3 shows only the circulation means of the temperature-control chamber, trays being located on the bearing elements, and

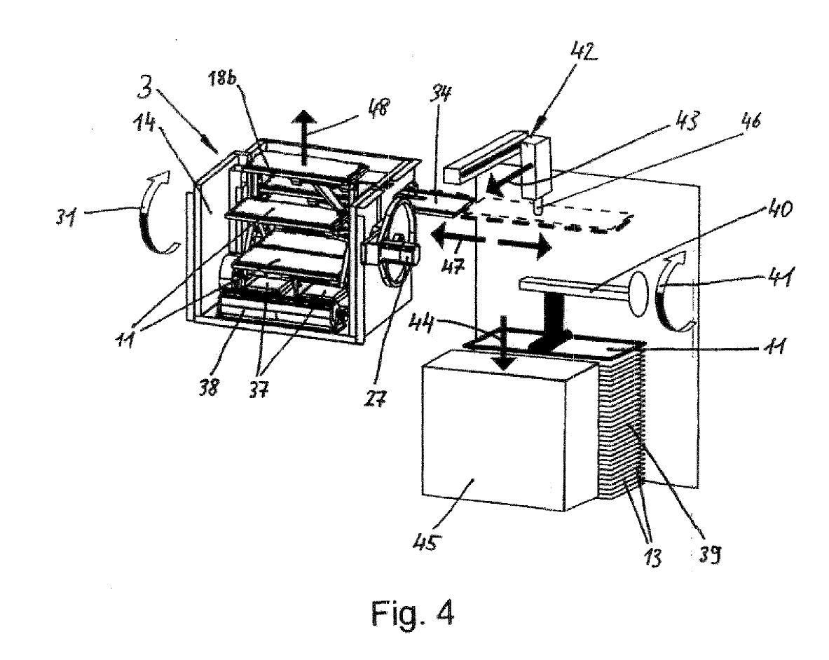

FIG. 4 is a schematic, partially exploded view of the temperature-control chamber according to the invention comprising a pick-and-place unit and a flipping unit for handling trays.

A possible system for testing electronic components in the form of ICs will first be described schematically and by way of example with reference to FIG. 1. In the figure, the arrows indicate the path of the components.

The components are initially conveyed to a loading unit 1. The loading unit 1 transports the components to a loading opening 2 of a temperature-control chamber 3 (temperature chamber), in order to bring them to the predetermined temperature within the temperature-control chamber 3. Once the components to be tested have been brought to the desired temperature in the temperature-control chamber 3, they are removed from the temperature-control chamber 3 via a removal opening 5 by a transport unit 4, which may be a pick-and-place unit for example, and are conveyed to a central handler unit 6. The central handler unit 6 contains the means required to pick up and hold the components, optionally means to carry out an additional component temperature-control process, and a component displacement means to convey the components to a test head 7 and, once the test process is complete, to remove the components from the test head 7 once more. The central handler unit 6 may also contain specific means to act on the components in a particular way, for example to exert acceleration or pressure on the components or to tilt them. The test head 7 is connected to the central handler unit 6 in a known manner. The test head 7 is part of an electronic test device which tests the components and evaluates the test results.

Once the test is complete, the components are removed from the test head 7 once more by the central handler unit 6 and are conveyed by a removal unit 8 (unloader or pick-and-place unit) to a sorting unit 9. In the sorting unit 9, the components are sorted depending on the test result. The components then reach a discharge station 10.

As an alternative to the embodiment shown, the temperature-control process may also be carried out in a temperature-control chamber 3 which is arranged completely inside the central handler unit 6. Furthermore, it is not necessary for the components to be conveyed to the central handler unit 6 by the transport unit 4 in the form of a pick-and-place unit, but they may instead be conveyed by the force of gravity, as is known to the person skilled in the art. In this case, this is achieved by what is known as a gravity handler.

The construction and the mode of operation of the temperature-control chamber 3 according to the invention will be described below with reference to FIGS. 2 to 4. In this embodiment, the temperature-control chamber 3 is constructed in such a way that it is suitable for receiving trays 11, on which a large number of components 12 rest. These trays 11 are special transport trays, which are adapted to the temperature-control chamber on the one hand and, on the other, enable components to be transferred from conventional trays 13 (FIG. 4) in which the components 12 are conveyed to the loading unit 1.

The temperature-control chamber shown in FIGS. 2 to 4 has a heat-insulated housing 14 in which a rotatable circulation means 15 for transporting the trays 11, and thus the components 12 placed on the trays 11, in a circular circumferential path, is arranged. The circulation means 15 comprises two spider wheels 16, 17 and bearing elements 18 on which the trays 11 holding the components 12 may be placed.

The two spider wheels 16, 17 are arranged in the vicinity of the two lateral walls 19, 20 and are rotatable in parallel vertical planes. The first spider wheel 16 is rotatable about a first axis of rotation 21, whereas the second spider wheel 17 is rotatable about a second axis of rotation 22. The two axes of rotation 21, 22 extend horizontally and parallel to one another, but are offset laterally by a distance a. The spider wheels 16, 17 are supported by stub shafts 23, 24 which are rotatably mounted in bearing brackets 25, 26.

The bearing brackets 25, 26 may be integrated into the lateral walls 19, 20 or arranged separately therefrom in the direct vicinity of the lateral walls 19, 20. Care should be taken to ensure that the stub shafts 23, 24 extend inwards only up to the respective spider wheel 16, 17, each spider wheel thus only being mounted on one side.

As can be seen in FIGS. 2 and 3 in particular, the spider wheel 17 is set into rotation by a drive motor 27, a drive belt 28 and a belt pulley 29 which is rotationally coupled to the stub shaft 24 which penetrates the lateral wall 20. The other spider wheel 16 is rotationally entrained by the bearing elements 18. In this way, the two spider wheels are rotated synchronously with one another in the same direction of rotation in a very simple manner. Alternatively, it is also possible to drive the two spider wheels 16, 17 synchronously by using drive motors.

In the present embodiment, the spider wheels 16, 17 comprise five rotary arms 30 which are of the same length, extend radially outwards from the centre of the spider wheels 16, 17 and are distributed regularly over the circumference of the spider wheels 16, 17.

The bearing elements 18 are arranged horizontally between the two spider wheels 16, 17. The bearing elements 18 consist of rectangular bearing plates or frames, the size of which in the embodiment shown is only slightly larger than that of the trays 11 resting thereon. As shown, the diagonally opposite corner regions of the bearing elements 18 are rotatably mounted in the free end region of the rotary arms 30 of the first spider wheel 16 on the one hand and in the free end region of the rotary arms 30 of the second spider wheel 17 on the other. Since the rotational positions of the two spider wheels 16, 17 are aligned with one another in such a way that the rotary arms 30 of the two spider wheels 16, 17 assume the same angular position and also since the two axes of rotation 21, 22 of the spider wheels 16, 17 are located adjacent to one another and offset in a horizontal plane, the trays 11 are always held in horizontal planes in any rotational position of the spider wheels 16, 17. The number of bearing elements 18, and therefore the number of the trays 11 which can be arranged thereon, thus corresponds to the number of rotary arms 30 of each spider wheel 16, 17. If the spider wheel 16 is rotated in the direction of the arrow 31 about the axis 21 and the spider wheel 17 is rotated in the direction of the arrow 32 about the axis 22, the bearing elements 18, and thus the trays 11 arranged thereon, are moved through the temperature-control chamber without the horizontal alignment of the trays 11 being affected.

As shown, the drive motor 27 and the belt pulley 29 are arranged outside the housing 14. It is therefore only necessary to guide the stub shaft 24 through the lateral wall 20 of the housing 14 and to form said stub shaft 24 in such a way that it is long enough for the belt pulley 29 to be fastened thereto.

As can further be seen from FIG. 2, the lateral wall 20 of the housing comprises a lateral loading and removal opening 33 to enable the trays to be loaded and removed parallel to the axes of rotation 21, 22 of the spider wheels 16, 17. The loading and removal opening 33 (which corresponds to the loading opening 2 in FIG. 1) is located in an upper region, i.e. in the relative vicinity of the upper closing wall of the housing 14 containing the removal opening 5 (FIG. 1) through which the temperature-controlled components 12 can be removed and conveyed to the central handler unit 6.

A horizontally-aligned transfer plate 34 on which the trays 11 can be placed, as described in greater detail below with reference to FIG. 4, extends horizontally outwards from the lateral loading and removal opening 33. The transfer plate 34 thus represents a laterally projecting loading ramp, by means of which the trays 11 can be introduced into the temperature-control chamber. In this process, the trays 11 are guided in guide grooves 35 which are provided on the upper side of the transfer plate 34 and of the bearing elements 18 in the vicinity of, and along, the lateral edges thereof Guide webs 36, located on the lower side of the trays 11 along the lateral edges thereof engage in these guide grooves 35.

In the position shown in FIG. 2, a rear bearing element 18a is located at exactly the same height as the transfer plate 34 and is aligned therewith in such a way that a tray 11 placed on the transfer plate 34 can be pushed from said transfer plate 34 into the interior of the housing 14 onto the bearing element 18a. In the same way, an empty tray 11, after it has passed through the temperature-control chamber 3 and the temperature-controlled component 12 has been removed from above via the removal opening 5, can be removed laterally from the temperature-control chamber 3 when the bearing element 18a with the empty tray 11 is aligned with the transfer plate 34.

As can further be seen from FIG. 2, two radiant heaters 37 and a further electric heating means 37a for producing the required temperature within the housing 14 are arranged in the base region of the temperature-control chamber 3 below the circulation means 15. A drum fan 38, which is also arranged in the base region of the temperature-control chamber 3 and extends over the majority of the width of the housing 14, ensures that the air heated by the radiant heaters 37 is distributed uniformly within the temperature-control chamber 3.

The mode of operation when loading and unloading the temperature-control chamber 3 will be described in greater detail below with reference to FIG. 4.

The components 11 which are to be temperature-controlled and subsequently tested initially rest in conventional trays 13 which are arranged on top of one another in the form of a stack. An empty tray 11 (transport tray) is placed on the stack 39 by a flip unit 40 in order to lift the top tray 13, together with the components 11 located therein, off the stack. The flip unit 40 rotates the tray 11, together with the tray 13 held thereagainst, upwards by 180° about a horizontal axis, as indicated by the arrow 41. The tray 13 is now upside down above the transport tray in such a way that the components 11 fall onto the transport tray 11. The now empty tray 13 is grasped by a pick-and-place device 42 arranged thereabove and is moved laterally in the direction of the arrow 43 and then placed laterally adjacent to the stack 39 in the direction of the arrow 44, thus forming a stack 45 of empty trays 13. For this purpose, the pick-and-place device 42 comprises, as is known in principle, a retaining head 46 which can be displaced in two orthogonal horizontal directions and in the vertical direction and optionally may also be rotatable about at least one axis.

The transport tray 11 which is held, together with the components 11, by the flip unit 40 in the raised position which is aligned with the plane of the transfer plate 34 is pushed by a device (not shown in greater detail) onto the transfer plate 34, as indicated by the arrow 47. From there, the transport tray 11 is pushed by a transport device (not shown in detail) into the interior of the housing 14 and onto the bearing element 18a which is positioned at the same height as the transfer plate 34.

The circulation means 14 is at that point caused to circulate by the drive motor 27 in such a way that the bearing element 18a, together with the tray 11 located thereon, rotates downwards by an angle of rotation of 72° (⅕ of 360°). In this first rest position, the adjacent bearing element 18b which previously was located in the highest position in the region of the removal opening 5, is now positioned at the same height as the transfer plate 34. An empty transport tray 11 which may be present on this bearing element can at this point be pushed laterally out of the housing 14 onto the transfer plate 34. From there, the tray can be brought into the engagement region of the flip unit 40 and be lowered thereby onto a full tray 13 on the stack 39 in order to raise the tray 13 filled with components 12 as previously described and to convey the transport tray 11, together with the not yet temperature-controlled components 11, to the transfer plate 34 and from there onto the waiting empty bearing element 18. The circulation means 15 is then rotated again by a 72° step, where the described procedures of removing and loading a transport tray 11 through the lateral loading and removal opening 33 are repeated.

By rotating the circulation means 15 in steps in the direction of the arrow 31, each bearing element 18 reaches the region laterally adjacent to the transfer plate 34 in such a way that it can be loaded with a transport tray 11 filled with components 11. Once a loaded bearing element 18 has covered ⅘ of its entire circulation path, it is located in its highest position directly below the removal opening 5 located in the cover portion of the housing 14. This uppermost bearing element is provided with the reference numeral 18b in FIGS. 2 to 4. The components 12 resting on the associated tray 11 can at this point be lifted by the transport unit 4 (pick-and-place unit) in the direction of the tray 48 and conveyed to the central handler unit 6 (FIGS. 1 and 4).

Since the removal position of the components 11 is directly before the loading position in the temperature-control chamber 3 in the direction of circulation of the circulation means 15, the emptied tray 11 must only be rotated further by a very small distance, namely 72°, in order to return to the loading position. The vast majority of the circulation path is thus available to control the temperature of the components 11. A further advantage is that the uppermost bearing element 18b is able, together with the tray 11 resting thereon, to close the upper removal opening 5 almost fully so the flow of heat through the removal opening 5 while the components 12 are removed can be minimised. Furthermore, the lateral loading and removal opening 33 can be kept very small and preferably closed by a slide or shutter mechanism so that the loss of heat through this loading and removal opening 33 can also be minimised.

1-9. (canceled)

10. Temperature-control chamber for controlling the temperature of electronic components, comprising:
a housing, into which components to be temperature-controlled can be inserted, and
a holding device structured to hold the components arranged within the housing, the holding device comprising a plurality of bearing elements which circulate in a circular manner and two support elements for the bearing elements which are arranged on opposite sides of the bearing elements, wherein the support elements consist of a first and a second spider wheel which are rotatable about parallel but laterally offset axes of rotation and comprise rotary arms on which the bearing elements are mounted in the diagonally opposite corner regions thereof in such a way that the alignment of the bearing elements remains unchanged as they circulate.

11. Temperature-control chamber according to claim 10, wherein the bearing elements consist of rectangular bearing plates or bearing frames which are formed to receive trays on which the components rest.

12. Temperature-control chamber according to claim 10, wherein the spider wheels comprise 2 to 10 rotary arms uniformly distributed over the circumference thereof.

13. Temperature-control chamber according to claim 10, wherein each bearing element is mounted on two bearings of the rotary arms which lie in a horizontal plane in such a way that the bearing elements are horizontally aligned.

14. Temperature-control chamber according to claim 10, wherein a loading and removal opening for loading and removing trays is arranged in a side region of the housing parallel to the axes of rotation of the spider wheels.

15. Temperature-control chamber according to claim 10, wherein a removal opening for removing temperature-controlled components vertically from the housing is arranged on the upper side of the housing.

16. Temperature-control chamber according to claim 10, wherein the housing comprises a loading and removal opening for trays and a removal opening for the temperature-controlled components, in that the circulation means stops at a plurality of circulation rest positions, and in that the loading and removal opening for trays and the removal opening for the temperature-controlled components are arranged adjacent to one another in such a way that the tray from which the temperature-controlled components are removed is, in the next circulation rest position of the circulation means, located in the region of the loading and removal opening for trays.
